(19) United States
(12) Patent Application Publication
(10) Pub. No.: US 2002/0032668 A1
(43) Pub. Date: Mar. 14, 2002

(54) System and methods for enabling person to person product transfer via a communications network

(76) Inventors: Robert Kohler, Mill Valley, CA (US); Patrick Ford, Alameda, CA (US)

Correspondence Address: Morrison & Foerster LLP, 425 Market Street, San Francisco, CA, 94105-2482, US

(21) Appl. No.: 09/759,487

(22) Filed: Jan. 12, 2001

Related U.S. Application Data
(60) Provisional application No. 60/176,109, filed on Jan. 14, 2000.
(60) Provisional application No. 60/186,954, filed on Mar. 4, 2000.

(51) Int. Cl. G06F 17/00

(52) U.S. Cl. 705/401

(57) ABSTRACT

A method and system for enabling a product transfer transaction between a buyer and a seller. The method includes receiving via a communication network a product request from a buyer to obtain products from a remote seller, determining an appropriate mailer to send to the seller for the seller to place the requested product in the mailer and send the mailer with the product to the buyer, and determining an appropriate postage amount to place on the mailer.

### RELATED APPLICATIONS

This application claims the benefit of U.S. Provisional Application No. 60/176,109 filed Jan. 14, 2000, and U.S. Provisional Application No. 60/186,954 filed Mar. 4, 2000, both of which are incorporated by reference herein in their entirety.

### COPYRIGHT NOTICE

A portion of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates to a computer method and system for enabling a buyer to initiate a product transfer with a remote seller, and more particularly, to a method and system for initiating such a product transfer using a communications network such as the Internet.

2. Description of the Related Art

The popularity of the Internet and World Wide Web allows sellers of goods to reach a large number of potential buyers. These sellers include not only merchants selling new merchandise, but individuals wishing to sell goods in their personal possession. There are a number of different kinds of web sites which enable individual sellers to post their goods for sale to other individuals or entities. These include barter/swap or purchase sites such as MrSwap.com, auction websites such as eBay, fixed price used goods sales sites like Half.com and numerous web sites that have merchandise for sale areas for web site visitors to view. There is a large population of people with products to sell. This is particularly so for products which have a limited life cycle because owners tire of the old product while acquiring new products, such as compact discs, video games, video tapes, digital video discs, vinyl record, laser discs, books, personal electronics and other media products or collectibles.

A necessary step in these transactions is the delivery of products by a seller to a buyer. Problems encountered by buyers and sellers include unreliable delivery, inconvenience to the seller in shipping products, uncertain allocation of shipping costs, and uncertainty regarding the status of a transaction. Potential purchasers of goods from such sites may be uncertain whether the seller will ship the products that have been purchased, and when the seller will ship such goods. Potential sellers of goods may be discouraged from offering items for sale if it is too inconvenient for the seller to effect the delivery of products to a buyer. For example, a seller wishing to delivery a compact disc or videotape to a buyer would have to procure an appropriate mailer, obtain the buyer address and place it on the mailer, obtain appropriate postage necessary to send the products to the buyer, and send the mailer. The need for a convenient way to ship products is particularly important when the value of each product shipped is relatively low in order to encourage potential sellers to offer such products for sale.

Thus, there has been a need for methods and systems that address these and other problems.

### SUMMARY OF THE INVENTION

The present invention encompasses systems and related methods for enabling a person to person product exchange initiated by a request over a communication network.

The invention provides a method for fulfilling a product transfer transaction between two entities, a buyer and a seller, by receiving via a communication network a product request from a buyer to obtain products from a seller, where the seller has possession of the products and is at a remote location from the buyer. A determination of the appropriate mailer for the seller to ship the products to the buyer is made, along with the appropriate postage amount to place on the mailer. The mailer with postage is then sent to the seller for the seller to place products in the mailer and send the mailer with the products to the buyer. A third party mailer center may be sent information concerning the appropriate mailer, appropriate postage amount, and the addresses of the seller and buyer. The third party mailer center sends an appropriate mailer with appropriate postage to the seller for the seller to place products in the mailer and send the mailer with products to the buyer.

The invention also provides a computer-implemented system for enabling a product transfer transaction between a buyer and a seller. The system includes a software application component for receiving via a communication network a product request from a buyer to obtain products from a remote seller. The software application includes a mailer determining component for determining an appropriate mailer to send to the seller for the seller to place the requested product in the mailer and send the mailer with the product to the buyer and a postage determining component for determining an appropriate postage amount to place on the mailer.

These and other features and advantages of the invention will be better understood from the following detailed description of a presently preferred embodiment of the invention in conjunction with the appended drawings.

### BRIEF DESCRIPTION OF THE DRAWINGS

FIG. 1 shows an architecture of a presently preferred embodiment of the invention.

FIGS. 2 and 2a show a flow diagram of the process of the present invention which enables a product transfer from a seller to a buyer.

FIG. 3 shows a table utilized by the postage engine to determine a postage amount to place on a mailer FIG. 4 shows a packing list prepared by the fulfillment center upon receiving an order from the server system of the present invention.

FIG. 5 shows a sender (i.e., the “seller”) mailing label prepared by the fulfillment center upon receiving an order from the server system of the present invention.

FIG. 6 shows a recipient (i.e., the “buyer”) mailing label prepared by the fulfillment center upon receiving an order from the server system.

FIG. 7 is an overview of the functionality of the server system of the present invention presented to a user.

FIGS. 8, 8A, 8B, and 8C show a flow diagram of the process of the present invention with additional features which enables a product transfer from a seller to a buyer.

FIG. 9 is a screenshot of the screen the server system presents to a user entering information about an item the user is making available for sale.

FIG. 10 is a screenshot illustrating a display of swap item totals and billing/shipping information to the buyer.

FIG. 11 is a screenshot of the screen the server system presents to a user entering information about an item the user is making available for sale.

FIG. 12 is a screenshot illustrating server system showing the buyer other items available from the selected seller.

FIG. 13 is an example of the confirmation email sent to seller when buyer requests to purchase an item from seller.

### DETAILED DESCRIPTION OF THE PREFERRED EMBODIMENT

The present invention encompasses methods and related systems for enabling a person to person product transfer. The following description is presented to enable any person skilled in the art to make and use the invention, and is provided in the context of a particular application and its requirements. Various modifications to the preferred embodiment will be readily apparent to those skilled in the art, and the generic principles defined herein may be applied to other embodiments and applications without departing from the spirit and scope of the invention. Thus, the present invention is not intended to be limited to the embodiment shown, but is to be accorded the widest scope consistent with the principles and features disclosed herein. Throughout this description, reference will be made to various implementation-specific details of the service as implemented on the Web site of MrSwap.com, the assignee of the present invention. These details are provided in order to fully set forth a preferred embodiment of the invention, and not to limit the scope of the invention; the scope of the invention is defined only by the appended claims. Thus, for example, although the invention is described in the context of compact discs, videos, and computer games, the invention is also applicable to other types of products. In addition, as a further example, although the invention is described in terms of buyers and sellers in either a swap based barter system or cash purchase system, the invention is applicable to any type of transaction in which one entity requests to obtain products from another entity, including but not limited to auction sites and sites which allow individuals and business to sell goods.

The site operates generally by offering a membership-based swap/barter and sales service community. Users can quickly search for items (e.g., compact discs, videos, computer games, DVDs, etc.) on the site by entering a few criteria in search boxes pertinent to the item, or browse items that can be purchased in a standard, directory-style interface. Members can initiate a purchase transaction utilizing either swap “points” or cash, which results in the fulfillment of a shipping mailer to the source of the item. The purchase is completed once the source has complied with the trade by sending the goods to the member who requested the item. Members can acquire multiple items from the same source member, allowing multiple point transactions to be made with various media types. Members may acquire goods using barter points, United States dollars (“cash”), or other types of currency. Seller members may select an asking price which may be in points and/or cash. Where points are used to acquire goods, users are awarded points for items that are “sold” through this process, creating an economy built upon points awarded for items swapped and thus traded. Where cash is used to acquire a good, users are awarded cash for items that are sold through this purchase, creating an economy built upon cash awarded for items purchased. The web site also allows users to purchase new and used items and obtain third-party reviews of items.

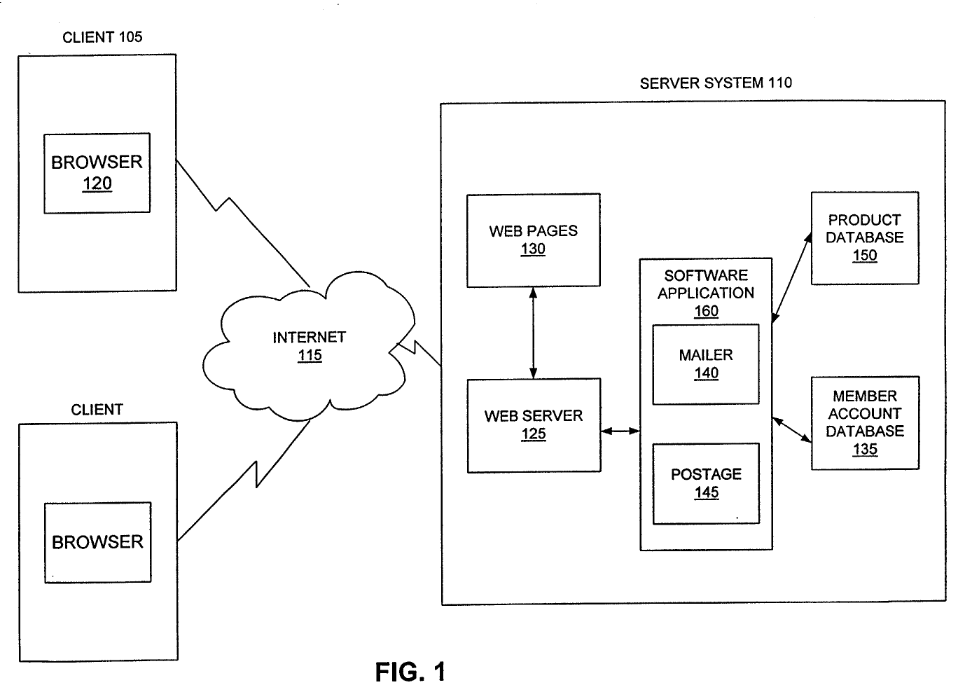

FIG. 1 illustrates the basic components of a presently preferred embodiment of a system that operates in accordance with the present invention. The system includes a user client computer 105 and a server system 110 which are linked together by the Internet 115. The user client computer 105 may be any type of computing device that allows a user (“member”) to interactively browse Web sites via a Web browser 120. For example, the member computer may be a personal computer that runs the Windows NT operating system.

The server system 110 is a web site that provides various functionality for allowing users to initiate purchase or “swap” transfers to obtain products from sellers of products. As described below, the server system 110 includes a software application 160 that implements the processes utilized by users of client computers 105 to initiate purchase of products. These processes are further described below, and include member registration, receiving and processing member requests for products, initiating the sending of confirmation and status emails to members, and providing transaction status information at the website. The software application 160 includes subcomponent software programs such as a mailer engine 140 and a postage engine 145, whose functions are described in further detail below. The server system 110 further comprises a product database 130 that stores catalog information relating to the products available in the marketplace for each category of product, including size and weight information, and a member account database 135 which stores certain data relating to each member.

In operation, a member accesses the server system 110 via a client computer 105 using a standard web browser 120, such as Microsoft's Internet Explorer, and the web browser 120 communicates with the web server 125 of the server system 110 utilizing HTTP protocol. The web server 125 accesses a local store of web pages 130 which can be requested, retrieved and viewed by a user at a client computer 105 using web browser 120. At the current time, web pages are typically defined using Hyper-Text Markup Language. These web pages may, for example, include information about registering online to become a member. Any information, such as contact information, product swap requests, and responses to emails sent by the server system 110 entered by a user at the client computer 105 are sent from the client computer 105 to the web server i25 for further processing in conjunction with the software application 160. The web server 125 initiates the software application 160 to process information received from the client computer 105. All communications between the server system 110 and a user at a client computer 105 described below are carried out in this manner.

The member account database 135 contains information concerning member contact information, swap points, cash account balance, shipping and handling credits, “my stuff”, “wish list” (items that a member wishes to purchase when available), member ratings, and other information. The member account database 135 includes information received from a member during member registration. The process of member registration collects the necessary information for processing member transactions, and optional information for better targeting of marketing to members. Member registration information includes Member name, password, contact and personal information, and member preferences. The first step in becoming a member is to create an identity by entering a Member Name of up to 25 characters, and a password of 4 to 10 characters. Members are asked to enter certain required contact and personal information: first and last name, email address, street address, city, state, zip code, country, date of birth, and telephone number. Optional information members may also include are title, middle initial, gender, and a member personal message/quote. Each new address and zip code are searched against valid mailing address databases and addresses are tested for validity to confirm that it is genuine and useable. Addresses will also be checked against a record of suspended users and flagged for investigation.

Members purchase items from other members utilizing swap “points” or cash that can be redeemed for items. Although reference may be made herein to swap transactions, these references are meant to encompass both purchases of items by buyers from sellers using swap “points” or cash. The number of points and cash each Member has available is stored in the member account database. Member sellers receive points or cash when they complete a transaction by sending an item to a member buyer. In order to initially populate the economy with points, members are granted “free” points when they register and are rewarded with bonus points when they request items for swap or purchase. It is in the member's best interest to sell multiple items at one time to reduce the average cost per item traded because the member pays a fixed cost of shipping and handling when swapping their items utilizing server system 110.

Members are encouraged to swap/buy multiple items in two ways. First, when a member (the “buyer”) requests a swap from another member (the “seller”) and still has points in his balance, he is given the option of viewing the list of other items that the “seller” has registered to encourage the buyer to request additional items. The second method uses a multiple item search algorithm to find members that have listed two or more items that appear on a members “wish list”. As members browse or search the product database 150, they can tag items that they would like to be added to their wish list. A buyer can use the buyer's wish list to find members that have multiple items that can be bought with swap points or cash.

The member account database contains a record of items each member has made available for sale (“my stuff”), either for points or cash. Members have several methods for entering their collections into the system. Members can register the items that they wish to make available for sale as well as those that they just want to have catalogued for future sale. Methods for entering items include, but are not limited to (1) entering information manually, (2) entry of the product UPC code, and (3) searching the product database of the item the member desires to enter and selecting the listed item from the search. Each item made available by a member is assigned a quality rating by the listing member. Members rate items on a four-point scale as follows:

New—Unopened, still in shrink-wrap

Excellent—Like new, but opened

Good—Shows some wear, but has all parts and no problems

Fair—Still in working condition, but has some minor problem (e.g., for CDs, missing liner notes, cracked jewel case, little brother wrote on it with a crayon). The member will be required to describe the deficiency for all items listed as “fair”.

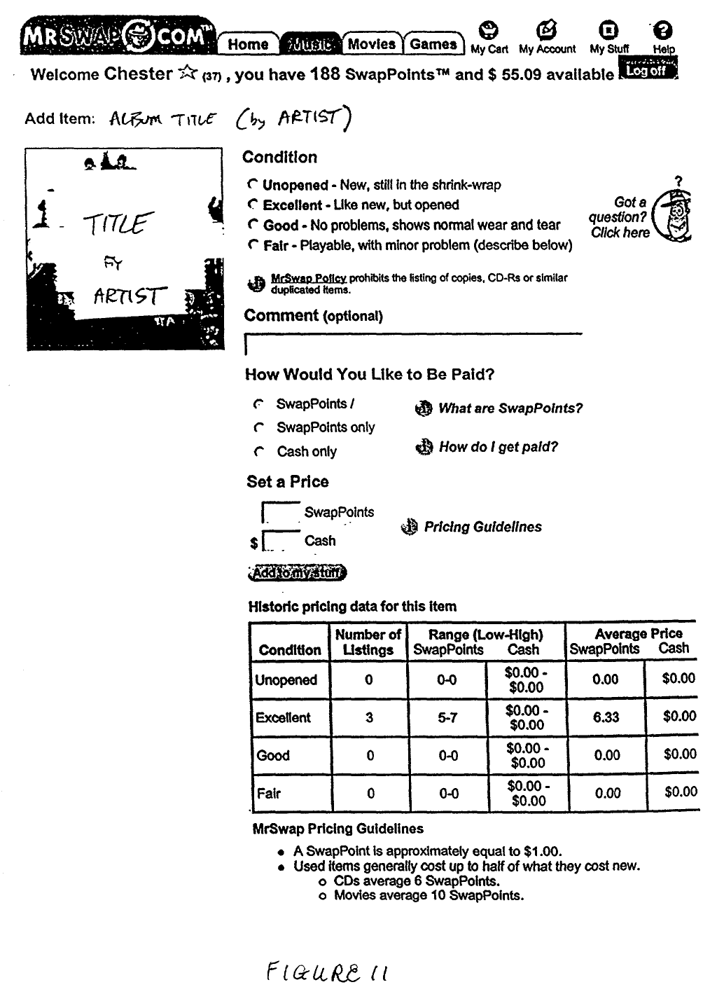

The user prices (in points or cash) each item listed. When a user (i.e., “seller”) selects an item of merchandise to be made available for sale on the server system 110, the software application 160 provides the user with several items of pricing information to assist him or her in determining an appropriate asking price (in terms of points or cash) for the item. First, the software application 160 will query the product database 150 and member account database 135 to determine what other “sellers” are asking for in terms of points for that particular item. The server system 110 will then display to the user the range (e.g., high, low and average) of the asking prices (in terms of points and cash) based on the assigned quality rating (new, excellent, good, etc.). For each asking price and quality rating, the server system 110 causes the number of items being offered to be displayed to the user. Also, the server system 110 provides the user with average prices and general price ranges (in terms of points and cash) for all merchandise of a particular type (CD, video, DVD, games, etc.) currently being offered on the server system 110. FIG. 11 is a screenshot of the screen the server system 110 presents to a user entering information about an item the user is making available for sale.

The member account database 135 will also maintain a current member rating for each member, which reflects the quality of trades/sales and cumulative reputations of members. Each member is assigned one of five possible ratings.

These are “new”, “thumbs down (suspended)”, “thumbs sideways (warning)”, “thumbs up”, and “gold star”. Additionally, gold star members carry a rating number that increases with each successful product shipment that they make. These will appear as icons next to their Member Names when displaying inventory or user profiles. In the presently preferred embodiment, every new member starts with the rating of “new”.

A Gold Star user is one that has built up a successful history of fulfilling at least one seller-side transaction (i.e., a transaction in which the user was the seller.) A Gold Star rating represents transactions having no problem reports from the buyer. A Gold Star rating provides member benefits including, without limitation, first notice when Wish List items arrive and top billing in the inventory display. A “New” icon is the default rating assigned to all new members. As long as no problems are reported or detected, the user will maintain this rating. If the user successfully completes a buy transaction, they will be upgraded to Thumbs Up status. A Thumbs Sideways rating means that some minor problems have been detected with the user. These may include letting a product request for one of their items expire unanswered. A Thumbs Down rating is reserved for users that have committed serious transgressions, which include failure to send a requested item after receiving a mailer, seriously overrating items (2 or more points different on the rating scale), sending poor-quality (non-working) items, engaging in abusive behavior toward other members. Members can improve flag status only by performing Gold Star merits which will warrant automatically moving upward in flag status.

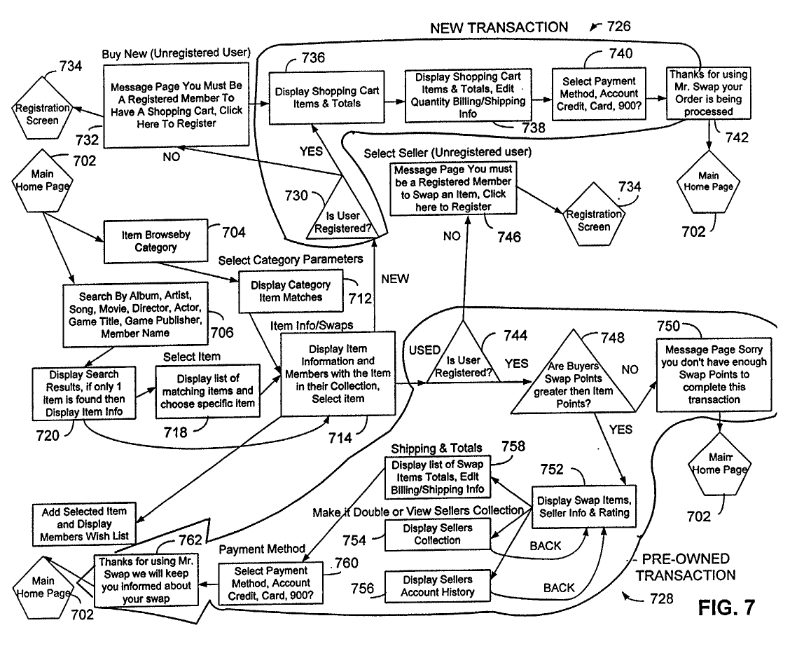

FIG. 7 is an overview of the functionality of the server system 110. A user is presented with a main home page 702 at which the user can either browse by category 704 or search by album, artist, song, movie, director, actor, game title, game publisher, or member name 706. If the user selects to browse by category 708, then the user selects category parameters 710 and the server system presents to the user category item matches 712, and item information and members with the item in their collection 714. Alternatively, if the user decides to search by album, artist, etc. 716, then the server system presents to the user the matching items. If more than one item is identified by the server system, the server system displays a list of matching items to the user for the user to choose a specific item 718. If only one item is identified 720, then the server system proceeds directly to displaying to the user item information and members with the item in their collection 722. At 724, the user can either select to purchase a new item via a new transaction 726 or purchase a pre-owned item via a swap transaction 728.

If the user selects to purchase an item via a new transaction 726, the server system queries the user whether the user is a registered member 730. If the user responds no, the server system informs the user that the user must register in order to obtain a shopping cart to purchase a new item 732. If the user chooses to register, the server system presents a registration screen 734 to the user. If the user is a registered member, the user enters his member name and password, and the server system displays the shopping cart items selected and totals 736, as is given an opportunity to edit quantity and billing/shipping information 738. The member then selects a payment method 740, and is informed the order is being processed 742. The member is then returned to the main home page 702.

If the user selects to purchase a pre-owned item 728, the user is again queried whether the user is registered 744. If the user responds no, the server system informs the user that the user must register in order to purchase an pre-owned item 746. If the user chooses to register, the server system presents a registration screen 734 to the user. If the user is registered, the software application 160 determines whether the user (the “buyer”) has sufficient points to purchase the selected items 748 by accessing the buyer account at the member account database 135. If not, the server system informs the buyer that he does not have enough points to complete the transaction 750, and the buyer is returned to the main home page 702.

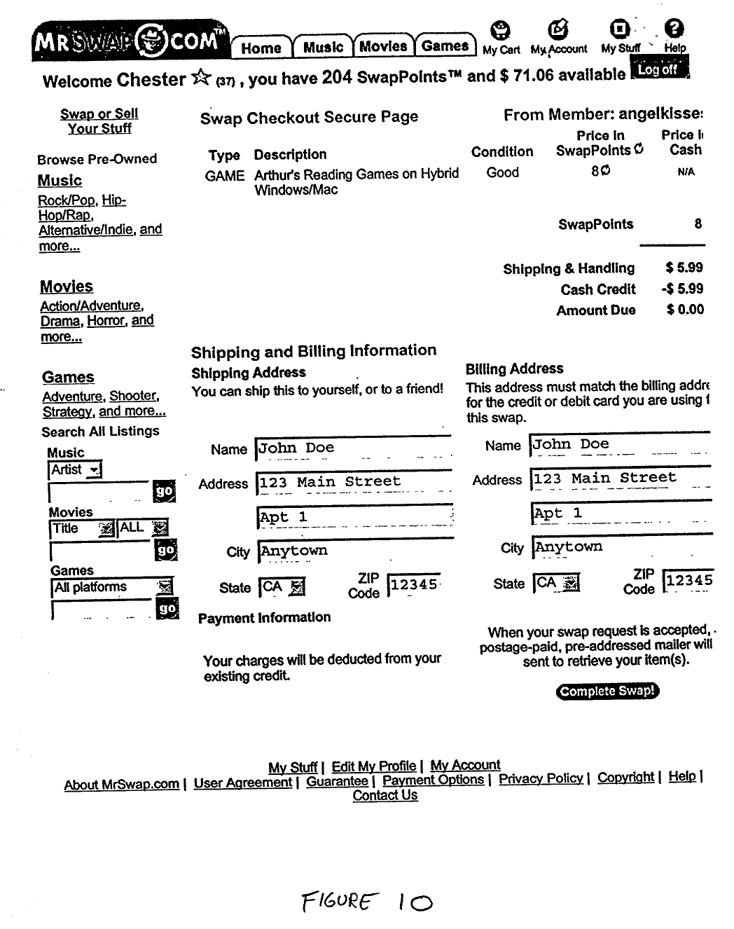

If the buyer has sufficient points to purchase the item, the item, seller information, and member rating is displayed to the buyer 752 by the server system. The buyer is given the opportunity to view the sellers collection 754 to decide whether to add additional items and view the sellers account history 756 to determine whether buyer wishes to purchase from this seller. If the buyer chooses to purchase items, the server system displays the item totals and the buyer is given the opportunity to edit billing/shipping information 758. FIG. 10 is a screenshot illustrating a display of item totals and billing/shipping information to the buyer. The member then selects a payment method 760, and is informed the server system will keep the buyer updated on the status of the transaction 762. The member is then returned to the main home page 702.

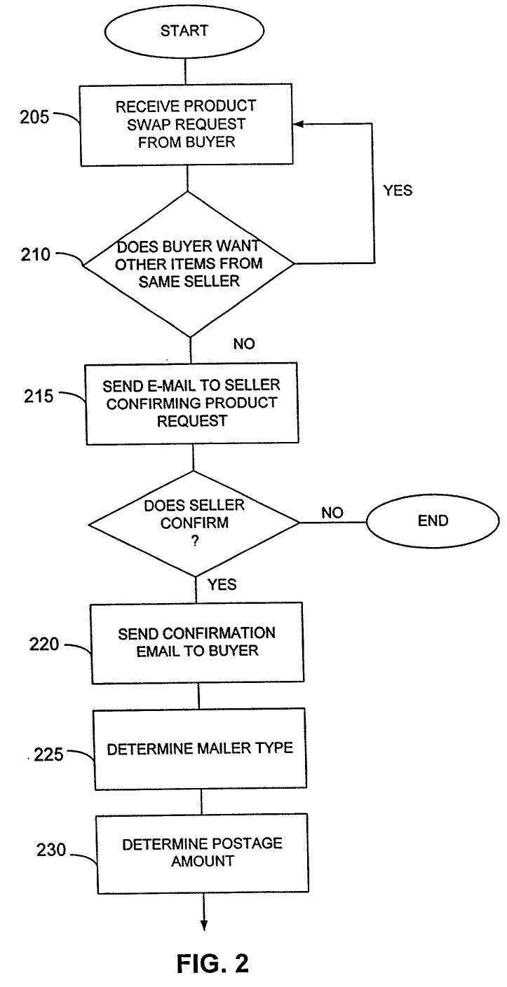

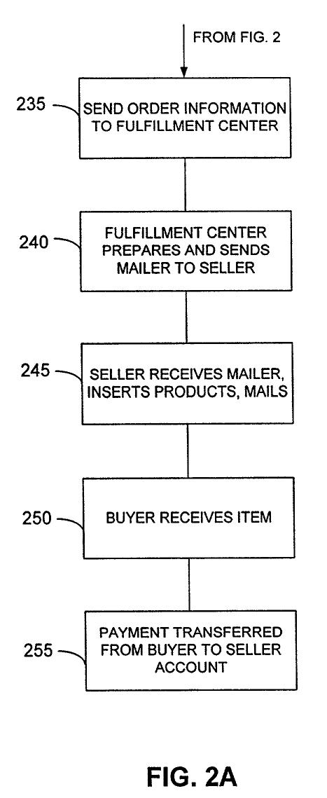

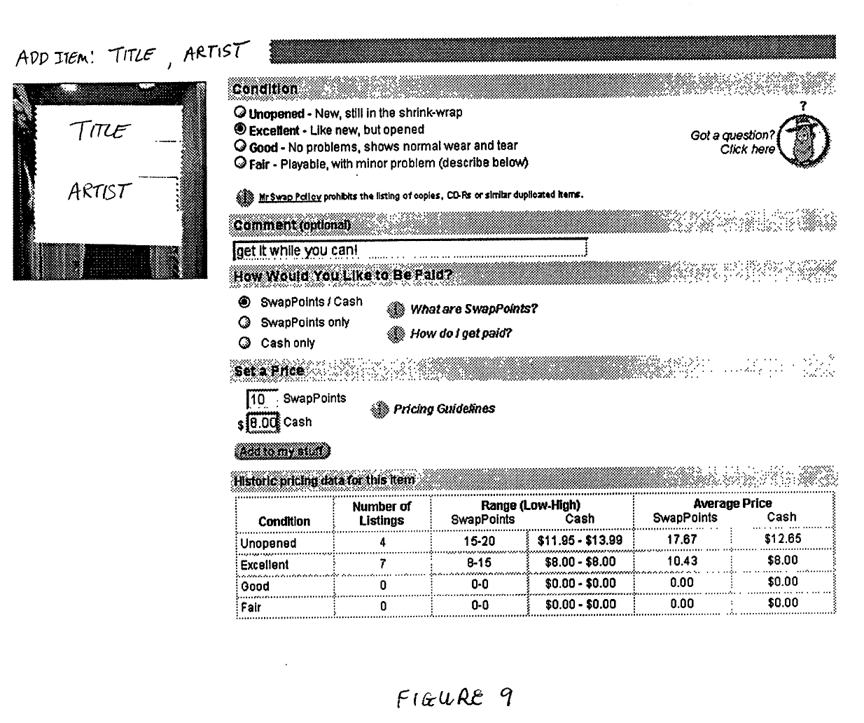

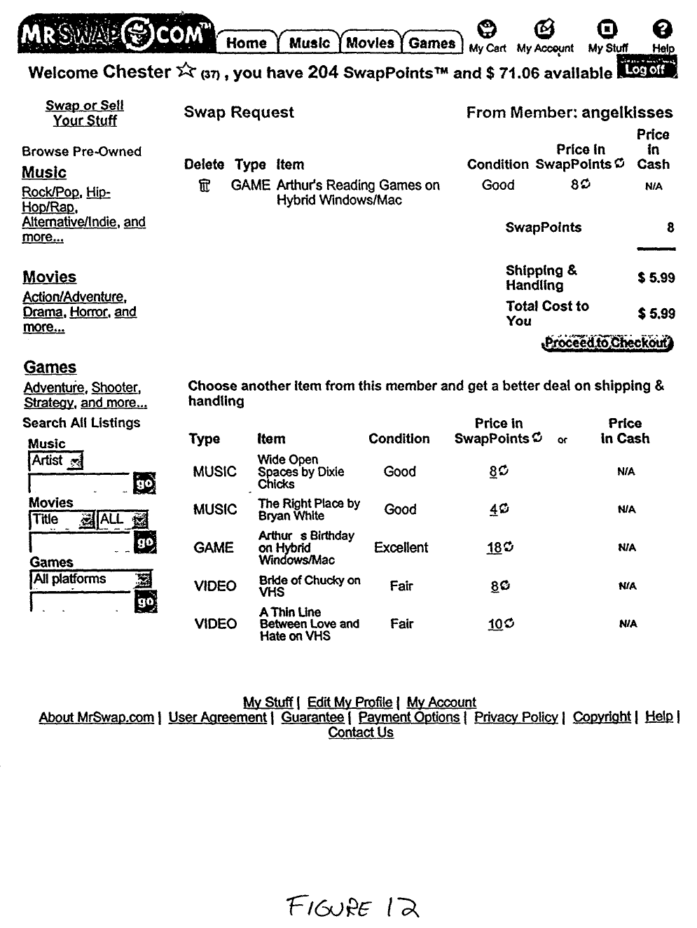

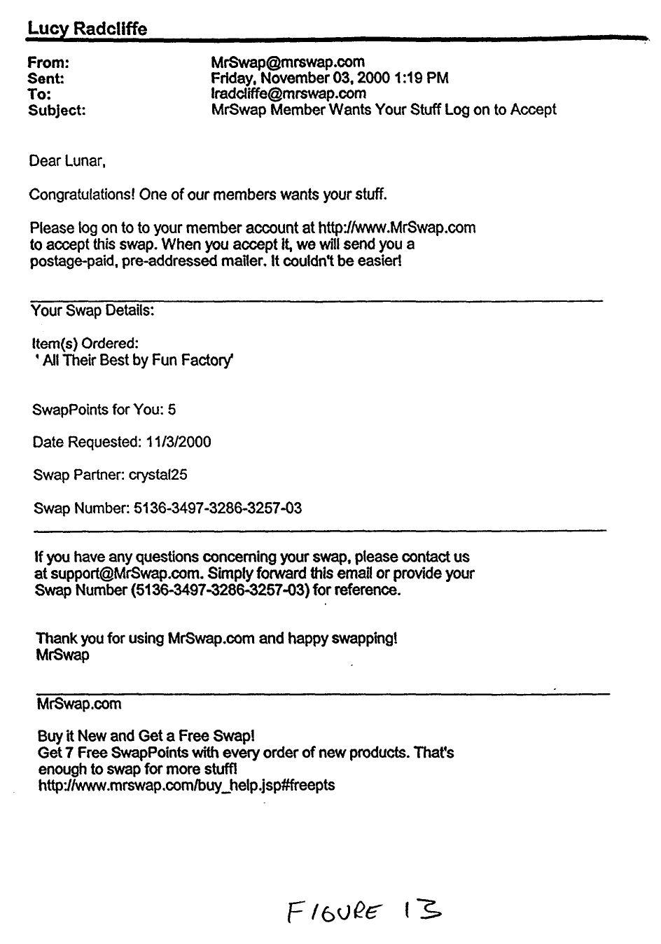

FIG. 2 is a flow diagram of the process which enables a member to enable a person to person product transfer of an item with another member using server system 110. At step 205, the server system 110 receives a product request from a member buyer to purchase an item from another member seller. FIG. 9 is a screen shot illustrating the screen presented to a buyer wishing to purchase a given item prior to selection by the buyer of a seller. At step 210, the server system 110 shows the buyer other items available from the same seller and queries the buyer whether he wants to acquire another item from the same seller. FIG. 12 is a screenshot illustrating server system 110 showing the buyer other items available from the selected seller. Once the buyer has selected all of the desired items to be purchased from the seller, at step 215 the server system 110 sends an email message to the seller asking the seller to either confirm or cancel the request by logging on to server system 110. FIG. 13 is an example of the confirmation email sent to the seller. If the seller confirms, at step 220 a confirmation email is sent to the buyer by the server system 110. If the seller declines the product request, the server system 110 sends a status update email to the buyer notifying buyer of the transaction decline.

At step 225, the mailer engine determines the type of mailer to be used by the seller to transfer products to the buyer. Inputs into the mailer engine are the size of items selected by the buyer for purchase from the seller (which in turn is determined by the type of item, e.g., compact discs, videocassettes, or video games), as well as the quantity of each type of item to be shipped. The mailer engine utilizes a point system to determine what type of mailer to use. Points are distributed by item and then totaled, and the number of total points is utilized to determine the mailer size based on a predetermined table. In the preferred embodiment, points are assigned as follows:

CD_POINTS=11

VHS_POINTS=30

DVD_POINTS=15

CARTRIDGE_POINTS=15

BOXEDGAME_POINTS=91

MAXPOINTS=185

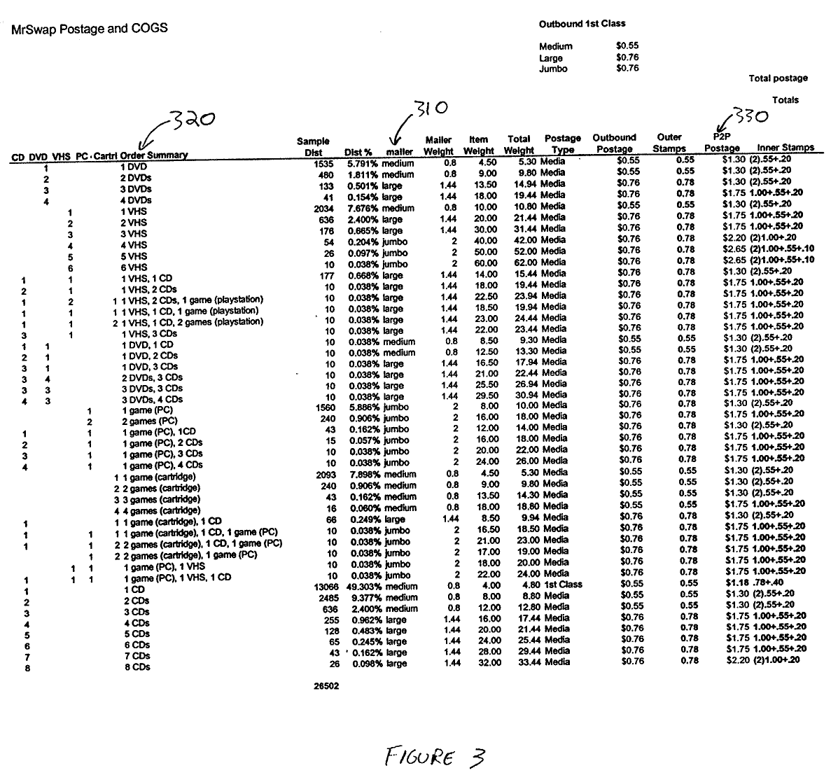

Each CD in a multiple CD set is counted as a separate item. Cartridge games include video games on platforms such as Nintendo, Sega, or Sony. Boxed games refer to PC/Mac games. A maximum point total that can be shipped using the largest mailer is identified by the identifier maxpoints. In the presently preferred embodiment, types of mailers include medium (7.5″ by 12″), large (10.5″ by 16″), and jumbo (12.5″ by 19″). If the total points are less than 35, the mailer engine outputs that a medium mailer should be used. If the total points are between 35 and 90, the large mailer is selected. The jumbo mailer is selected if the total points are greater than 90. FIG. 3 shows a table which includes the results of the output of the mailer engine 310 for various combinations of items 320. For combinations of items appearing in FIG. 3, the table is used as a lookup table to determine the mailer type based on the type and quantity of items ordered.

At step 230, the postage engine determines the postage amount to place on the mailer to be used by the seller to transfer products to the buyer and the amount charged to the buyer. In one embodiment, the postage engine receives as its input the type and quantity of items being shipped and the type of mailer selected by the mailer engine. The postage engine utilizes two tables to determine the appropriate postage: (1) a weight table that includes entries for how much each kind of item (e.g., compact discs, videocassettes, boxed games) weighs as well as how much each size mailer weighs, and (2) a postage lookup table which maps weight to postage amount for all postage categories from 1 to 64 ounces. The postage engine totals the weight for all the items plus the mailer utilizing the weight table and then determines the amount of postage from the postage lookup table. This postage amount is the amount of postage that will be placed on the mailer that the seller places swapped items in for mailing to the buyer. FIG. 3 shows a table which includes the results of the output of the postage engine 330 for various combinations of items 320. For combinations of items appearing in FIG. 3, the table is used as a lookup table to determine the postage amount that will be placed on the mailer that the seller places purchased items in for mailing to the buyer. In the preferred embodiment, the postage amount is for delivery of items by the U.S. postal service using media mail class or first class. In alternative embodiments, other classes of delivery may be used or other delivery carriers may be utilized which have different delivery charges and classes of delivery. In alternative embodiments, the postage engine may receive as inputs the carrier to be used (e.g., Federal Express, UPS, etc.), the class of delivery (e.g., first class, next day air, etc.), and level of proof of delivery (e.g., return receipt requested, etc.), which may be selected by a buyer after query from the server system 110.

The buyer is charged a cash amount greater than the postage amount placed on the mailer. The postage engine utilizes two tables (a BASE table and an ADDITIONAL table) to determine the buyer charge amount. One table is for “base” items, the second table is for “additional” items. Each shipment will have 1 base item and as many additional items as there are in the swap order. The most expensive type of item being shipped is identified and designated the base item. As an example, in one embodiment, the item types used to determine which is the most expensive in order of most expensive to least expensive are:

Boxed Game

Cartridge Game

VHS

DVD

CD

The buyer charge amount is determined from the BASE charge table. For each additional item, an additional charge amount from the ADDITIONAL charge table is determined and added to the running total.

At step 235, the server system 110 sends via email information necessary for swap fulfillment to a fulfillment center. In the preferred embodiment, the fulfillment center may be operated by the owner of the server system 110, but in alternative embodiments this fulfillment center is a third party. Order information sent includes: name and addresses of the buyer and seller, description of items to be purchased, the mailer and postage engine determined mailer and postage amount. A list of targeted advertisements and other inserts may also be included with the order information.

At step 240, the fulfillment center prepares the mailer that the seller uses to ship items to the buyer and sends it to the seller. Processing at the fulfillment center is describe in reference to FIGS. 4-6. FIG. 4 shows a sender packing list 400 prepared by the fulfillment center upon receiving an order from the server system 110. The fulfillment center inserts the sender packing list 400 into the mailer that is delivered to the sender (the seller of the merchandise). In alternative embodiments, additional inserts such as padding, other packing materials, and descriptions of other offered services may be inserted into the mailer. The packing list 400 is prepared based on the information received from the server system 110 and includes the list of merchandise 410 that the sender will send to the recipient using the mailer.

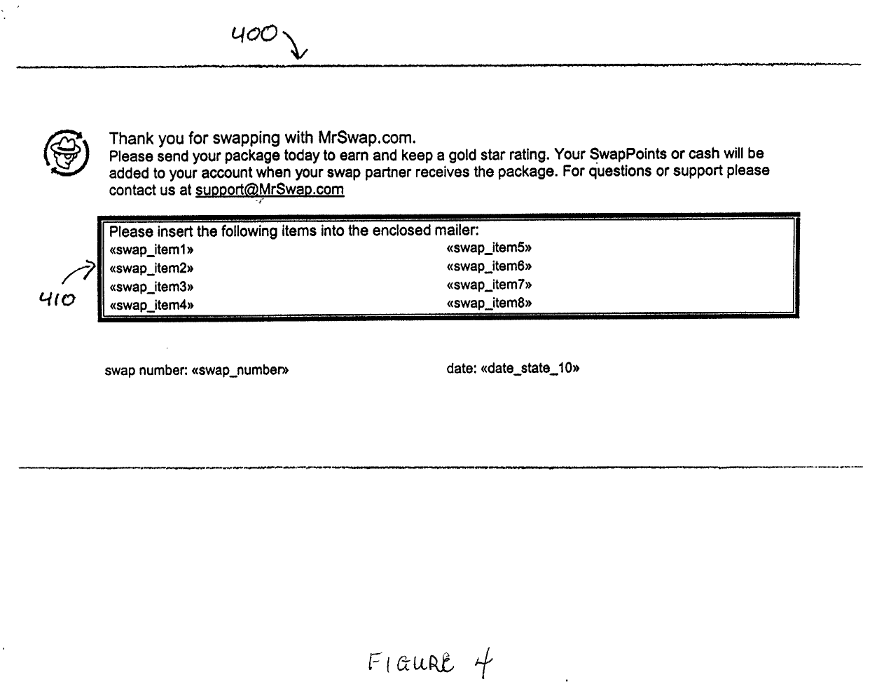

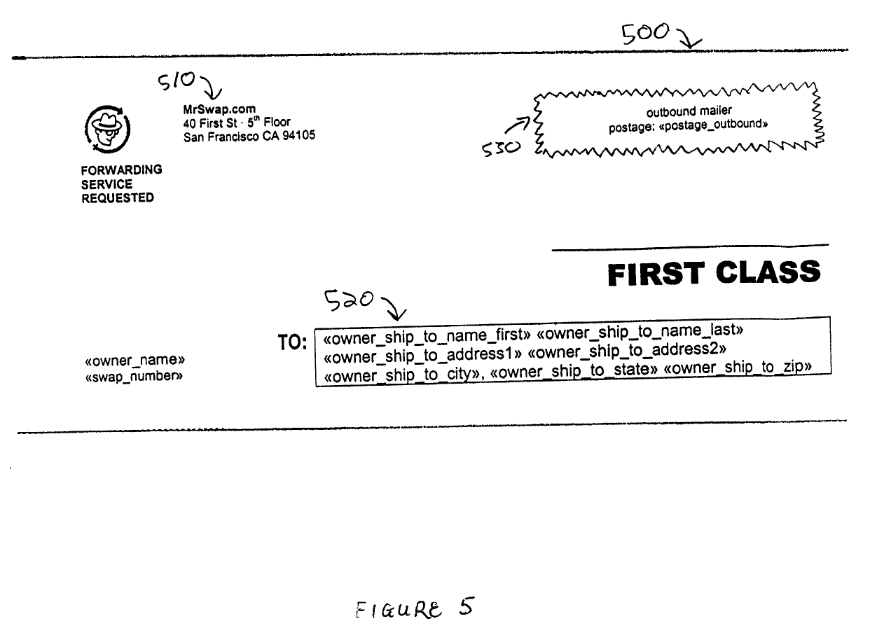

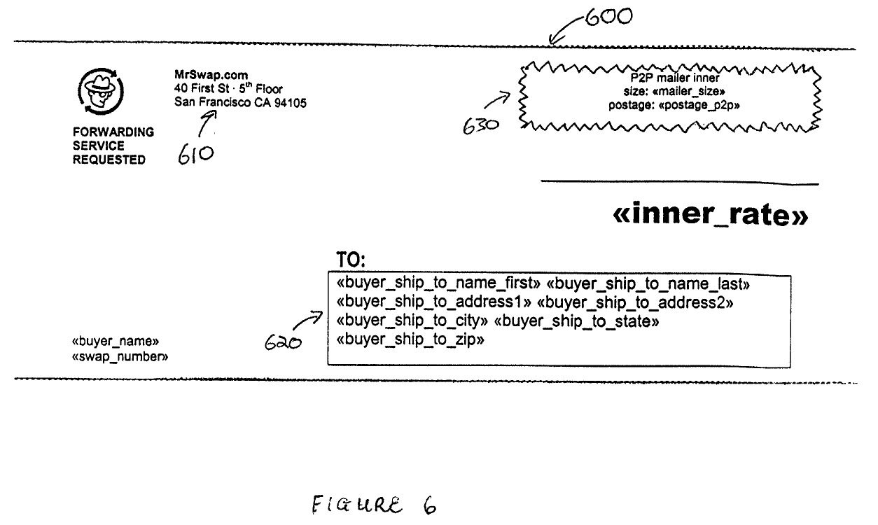

FIGS. 5 and 6 show a sender (i.e., the “seller”) mailing label 500 and a recipient (the buyer) mailing label 600 also prepared by the fulfillment center upon receiving an order from the server system 110. The mailing labels 500 and 600 are prepared based on the information received from the server system 110. The sender mailing label 500 includes the fulfillment center's address 510, the sender's address 520 and possibly other routing information. The recipient mailing label 600 includes a return address 510, which may be an address generated by an “anonymizer” that is associated with the fulfillment center to protect the confidentiality of the sender, the recipient's address 620 and possibly other routing information. The fulfillment center also prepares sender and recipient postage labels to provide the appropriate postage (e.g., either first or third class) for mailing the mailer from the fulfillment center to the sender 530 and from the sender to the recipient 630, respectively. The server system 110 calculates the appropriate postage for the sender and recipient postage labels based on various factors, including the type of merchandise to be mailed and the location of the sender's and recipient's mailing address.

The mailer(s) used in the fulfillment process will now be described. In one embodiment of the invention, two mailers (not shown) are used: a first mailer and a second, smaller mailer that fits into the first mailer. The fulfillment center affixes the sender mailing label 500 and the sender postage label to the first mailer and the recipient mailing label 600 and the recipient postage label to the second mailer. The fulfillment center then inserts the second mailer and packing list 400 into the first mailer and mails the first mailer (containing the second mailer) to the sender. Upon receiving the first mailer, the sender removes the second mailer from the first mailer, encloses the merchandise in the second mailer and mails the second mailer to the recipient. The first and second mailers may comprise standard shipping packages or containers, although custom designed packages or containers may also be used.

In another embodiment of the invention, a single, reusable mailer (not shown) is used in the fulfillment process. The reusable mailer includes a removable flap attached to the body of the mailer. The fulfillment center affixes the sender mailing label 500 and the sender postage label to the removable flap and the recipient mailing label 600 and the recipient postage label to the body of the mailer in a location underneath the flap. The fulfillment center then inserts the packing list 400 into the reusable mailer and mails the mailer to the sender. Upon receiving the mailer, the sender removes the flap from the reusable mailer, thereby exposing the recipient mailing label 600 and the recipient postage label, encloses the merchandise in the mailer and mails the mailer to the recipient. The reusable mailer may comprise a standard reusable mailer as used in the industry or one that is custom-designed.

At step 245, the seller receives the empty second stage mailer, inserts the item(s) to be purchased, seals the mailer, and drops it back in the mail. At step 250, the buyer receives the package and removes the requested items and any advertising materials that have been directed at the buyer. At step 255, payment is transferred from the buyer account to the seller account.

In order to track the progress of the transaction, and to encourage members to respond in a timely manner, email reminders are sent by the server system 110 on the expected date of arrival of packages, and members are asked to confirm the receipt and/or mailing. In addition, members are prompted to confirm any open transactions if and when they log on the server system 110 if they have not already sent replies to email queries.

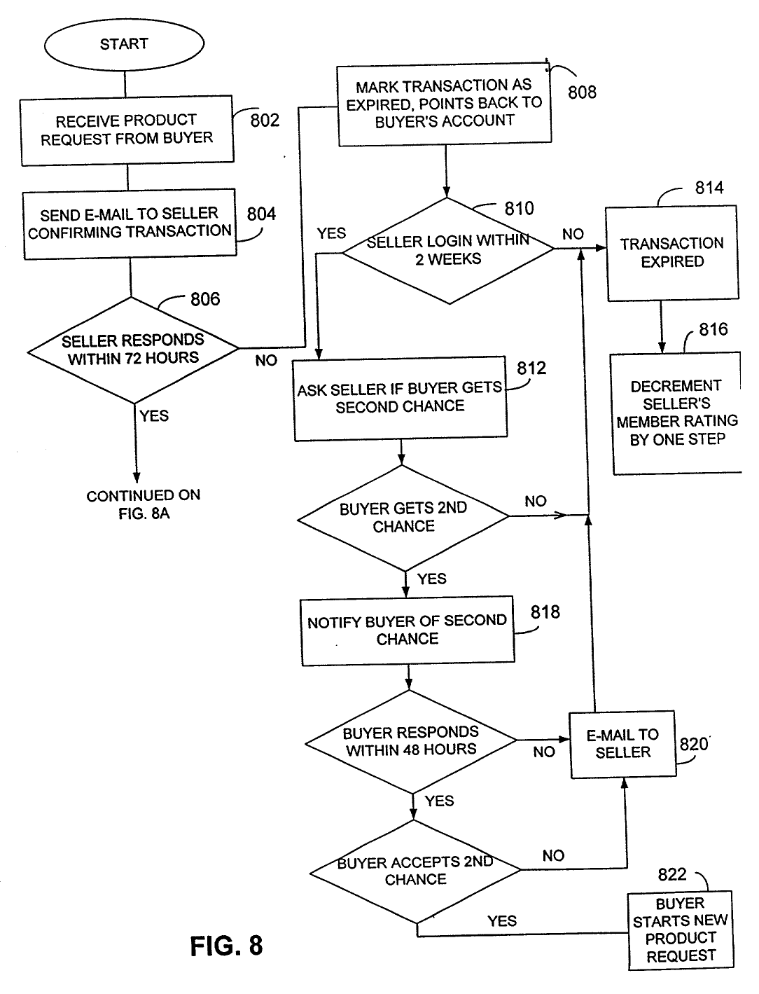

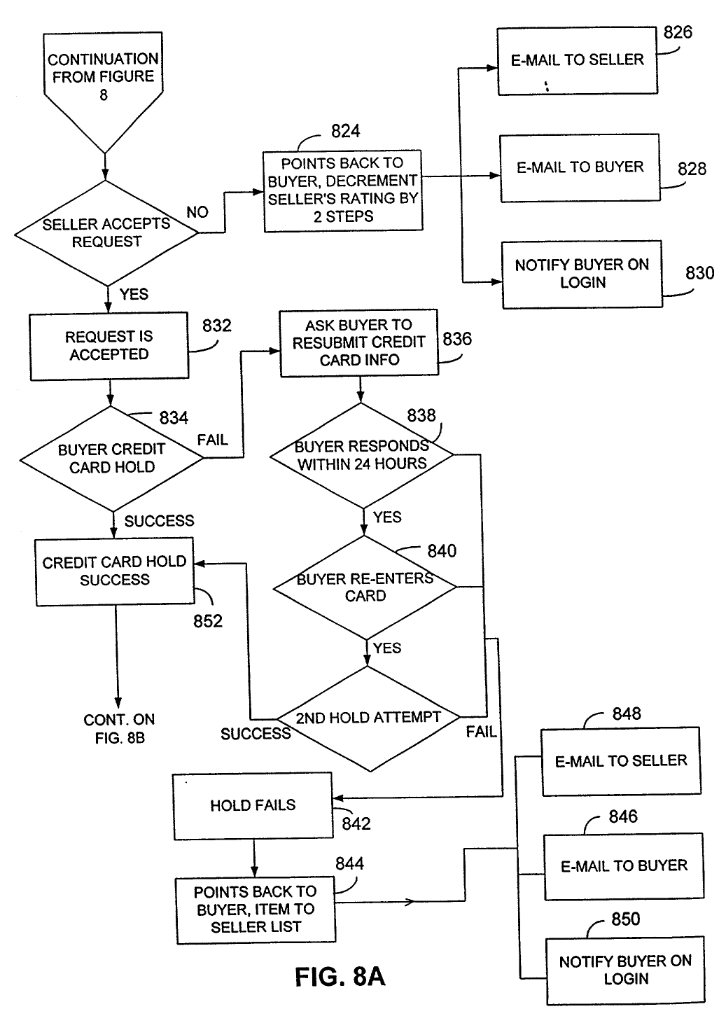

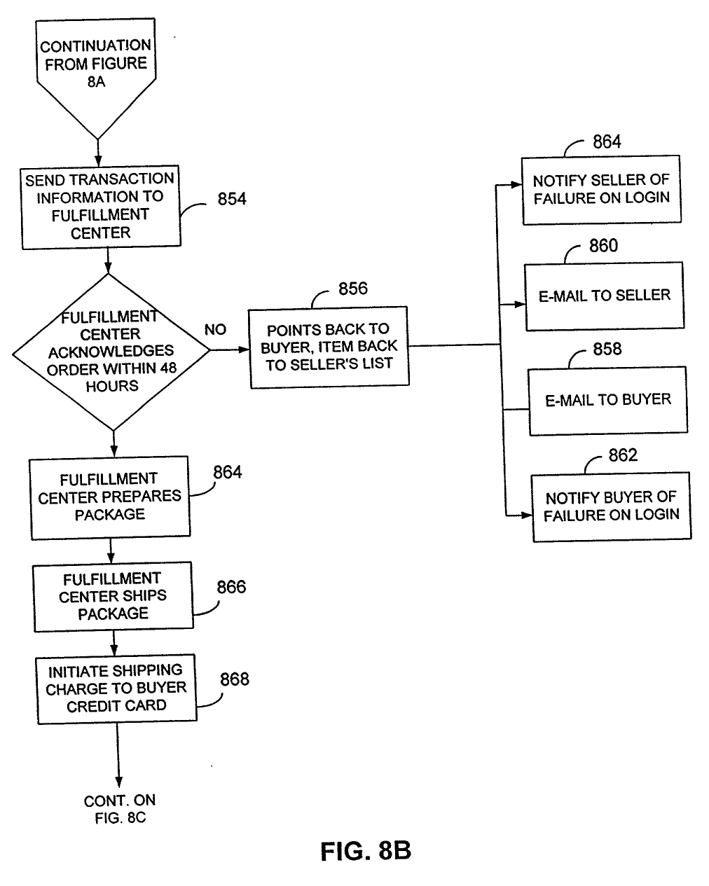

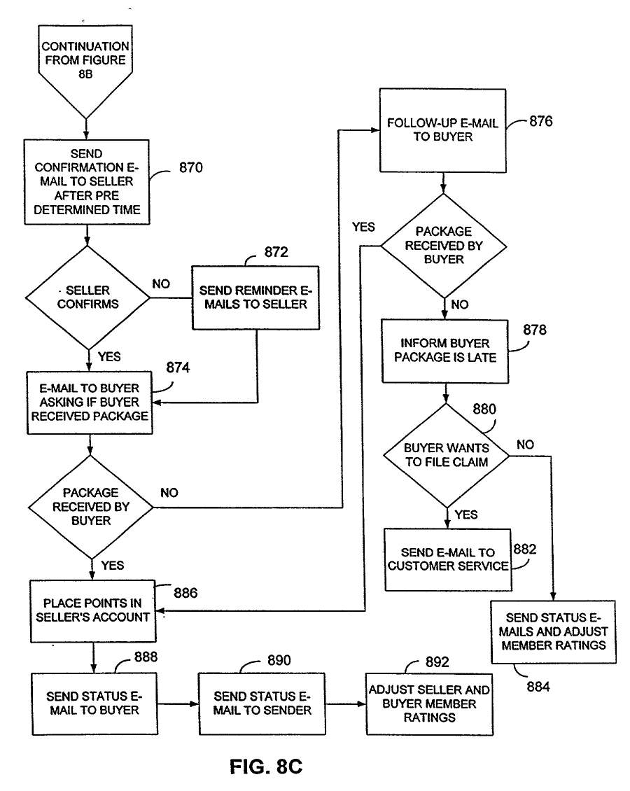

The process described above also offers additional novel features to facilitate transactions between members to ensure that the process works smoothly and intuitively. These features include smooth processing of postage charges to buyers, current member ratings to assist buyers in determining whether they wish to purchase from a given seller, clearly stated instructions, and useful status update emails to both buyers and sellers during the product transfer process. These additional features are described in further detail below. With reference to FIGS. 8, 8A, 8B and 8C discussed below, references made to the server system, software application, member account database, and client computer are reference to the server system 110, software application 160, member account database 135, and client computer 105 shown in FIG. 1. Although reference in the figures and description below is made to the use and transfer of points, a buyer may also use cash to purchase the requested products.

Referring to FIG. 8, the server system receives a product request from a buyer. After the server system sends an email to the seller asking the seller to confirm or cancel the purchase 804, the seller is given a period of 72 hours in which to confirm that the seller will fulfill the product request of the buyer 806. If the seller fails to confirm within 72 hours, points which have been deducted from the buyer's member account are replaced 808. The transaction is marked as “expired” by the software application, and status update emails are sent to both the buyer and seller. If the seller initiates a connection with the server system from a client computer during the next two weeks 810, the software application asks the seller if they want to give the buyer another chance to obtain the requested items 812. If the seller responds no, the request is marked as expired 814, and the sellers member rating is decremented by one step 816. If the seller responds yes, the buyer is notified of another opportunity to initiate the transaction if buyer desires 818. If the buyer fails to respond within 48 hours or rejects the second chance, a status update email is sent to seller notifying seller that the request has been marked expired 820, and the software application decrements sellers member rating by one step in the member account database 816. If the buyer accepts the second chance, the server system presents the buyer with a page with the previous transaction set up for buyer to initiate.

If the seller declines the product request following receipt of the email from the server system asking the seller to confirm or cancel the request, swap points deducted from the buyer's member account are replaced in the member account database, the requested item is deleted from the seller's item list, and the seller's member rating is decremented by 2 steps in the seller's member account 824. Status update emails are sent to both the seller 826 and buyer 828, and the buyer is notified of the transaction decline the next time buyer initiates connection with the server system with a client computer 830.

If the seller accepts the product request by sending a confirmation email to the server system 832, a buyer credit card hold is initiated for the shipping charges to ensure that shipping charges can be charged to buyer at a later time 834. If the hold fails, the server system 110 sends the buyer an email requesting buyer to resubmit credit card information 836. If the buyer fails to resubmit credit card information within 24 hours 838, or resubmits credit card information 840 and a second hold attempt fails 842, the swap transaction is cancelled. Software application 160 replaces points that were deducted from the buyer's member account in the member account database, returns the swap item to the seller's item list 844, sends status update emails to the buyer 846 and seller 848, and notifies buyer and seller of the failed transaction upon login by the buyer and seller to the server system 850.

If the buyer credit card hold succeeds 852, the transaction information is sent to a fulfillment center via email 854 following determination of the mailer type and determination of the postage amount as described previously in reference to FIG. 2. If the fulfillment center fails to acknowledge and confirm that it will fulfill the transaction within 48 hours, after a second acknowledgement request is made, the transaction is cancelled. The software application replaces swap points that were deducted from the buyer's member account in the member account database returns the item to the seller's item list 856, sends status update emails to the buyer 858 and seller 860, and notifies buyer 862 and seller 864 of the failed transaction upon login by the buyer and seller to the server system.

If the seller confirms that it will fulfill the product request, status update emails may be sent to the buyer and seller by the server system, as well as notification upon login by the buyer and seller to the server system. The fulfillment center prepares the swap package (comprising the mailer with appropriate postage) 864, and ships the package 866. The software application initiates a charge to the buyer credit card for the shipping charge 868. If the charge fails, the buyer is requested to resubmit credit card information and further charge attempts are made.

After a predetermined time following shipping of the product package to the seller by the fulfillment center, server system sends an email to seller asking seller to confirm that seller has received the swap package, inserted the requested items, and sent the product package 870. If server system does not receive a confirmation response within a predetermined time, subsequent reminder emails are sent by the server system periodically until seller confirms sending 872. Regardless of whether seller confirms that the package has been sent, after a predetermined time period, the server system sends the buyer an email asking buyer if buyer received the swap package 874. If the buyer responds no, then following a predetermined period another email is sent to buyer asking buyer if buyer received the product package 876 and buyer is also notified if buyer logs into the server system. If buyer responds no again and a predetermined period has passed since seller accepted the product request, buyer is notified that the package is late 878, and buyer is asked whether he wishes to file a claim 880. If buyer responds yes, status update emails are sent to both the buyer and seller, and the claim is emailed to a customer service center 882. If the buyer responds no, status emails are sent to the buyer and seller and seller's member rating is adjusted 884.

If the seller confirms that seller sent the product package, after a predetermined time the server system sends the buyer an email asking buyer if buyer received the product package. If the buyer responds no, then following a predetermined period another email is sent to buyer asking buyer if buyer received the swap package and buyer is also notified if buyer logs into the server system. If buyer responds no again and a predetermined period has passed since seller accepted the product request, buyer is notified that the package is late, and buyer is asked whether he wishes to file a claim. If buyer responds yes, status update emails are sent to both the buyer and seller, and the claim is emailed to a customer service center. If the customer resolves the claim in favor of the buyer, shipping costs charged to the buyer are refunded, and points removed from the buyer's member account are replaced. Status update emails are sent to both buyer and seller.

If the buyer responds that buyer has received the package, points that were removed from the buyer's member account upon buyer's initiation of the swap transaction are placed by the software application into the seller's member account in the member account database 886. Status update emails are sent to the buyer 888, and to the seller that the transaction has been completed and that seller's member account has been credited with more swap points 890. The software application adds 1 star to the seller's member rating in the member account database 892. If the buyer's member rating is “new”, the software application changes the buyer member rating to a thumbs-up in the member account database.

1. A method for enabling a product transfer transaction between a buyer and a seller, comprising:
receiving via a communication network a product request from a buyer to obtain a product from a seller, wherein the seller is at a remote location from the buyer;
determining a mailer to send to the seller for the seller to place the requested product in the mailer and send the mailer with the product to the buyer; and
determining a postage amount associated with the product request for placement on the mailer.

2. The method of claim 1, further comprising the step of sending information on the mailer, the postage amount, and a buyer and seller address to a fulfillment center, wherein the fulfillment center sends the mailer with postage to the seller for the seller to place products in the mailer and send the mailer with products to the buyer.

3. The method of claim 1, further comprising the step of processing a charge to the buyer based upon the product request.

4. The method of claim 1, wherein a currency quantity is transferred from the buyer's account to an account of the seller.

5. The method of claim 4, wherein the currency quantity comprises points accumulated from a previous product transfer.

6. The method of claim 4, wherein the currency quantity required to purchase the requested product is predetermined by the seller.

7. The method of claim 6 further comprising displaying to the seller pricing information of similar items by other sellers.

8. The method of claim 1, further comprising the step of sending a confirmation request to the seller that the seller confirm seller will fulfill the product request.

9. The method of claim 8, wherein a performance rating of the seller is adjusted based on whether the seller confirms or cancels the product request from the buyer in response to the confirmation request.

10. The method of claim 8, wherein the product request is cancelled if the seller fails to respond to the confirmation request within a predetermined time.

11. The method of claim 8, wherein a performance rating of the seller is adjusted based on whether the seller confirms or cancels the product request within a predetermined time frame.

12. The method of claim 1, further comprising sending a confirmation request to the buyer that the buyer confirm buyer has received the requested product.

13. The method of claim 1, wherein the step of determining a mailer for the seller to ship the products to the buyer is based on the number and type of products requested by the buyer.

14. The method of claim 1, wherein the step of determining a postage amount to place on the mailer is based on the weight of the products requested by the buyer and the weight of the mailer.

15. The method of claim 1, wherein the step of receiving via a communication network a product request from a buyer to obtain products from a seller further comprises:
identifying other products available from the seller that are available; and
displaying the other available products to the buyer so that the buyer can request additional products from the seller.

16. The method of claim 1, further comprising displaying to a buyer a member rating of a seller.

17. The method of claim 1, further comprising:
receiving from the buyer the name of a carrier to deliver the mailer; and
receiving from the buyer the class of delivery.

18. The method of claim 17, further comprising receiving from the buyer a proof of delivery requirement.

19. A computer-implemented system for enabling a product transfer transaction between a buyer and a seller, comprising:
a software application component for receiving via a communication network a product request from a buyer to obtain products from a seller, wherein the seller is remote from the buyer, including:
a mailer determining component for determining an appropriate mailer to send to the seller for the seller to place the requested product in the mailer and send the mailer with the product to the buyer;
a postage determining component for determining an appropriate postage amount to place on the mailer; and
a data storage component for storing information on a plurality of buyers and sellers.

20. The system of claim 19, wherein said data storage component contains a record of products each seller has available for transfer.
